(19) United States
(12) Patent Application Publication
(10) Pub. No.: US 2021/0302978 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP); Hidekazu OHNISHI, Saitama (JP)

(73) Assignee: HONDA MOTOR CO., LTD., Tokyo (JP)

(21) Appl. No.: 17/212,758

(22) Filed: Mar. 25, 2021

(30) Foreign Application Priority Data
Mar. 30, 2020 (JP) 2020-061642

(51) Int. Cl. G05D 1/02; G07C 5/02

(52) U.S. Cl. CPC G05D 1/0214; G05D 1/0287; G07C 5/02

(57) ABSTRACT

An accommodation area management device includes an acquisition unit configured to acquire information on a moving body which includes information indicating an autonomous movement performance of the moving body, and a control unit which causes a first moving body to enter an accommodation area after notifying the first moving body of a first route which is a movement route of the first moving body in the accommodation area when the first moving body having a predetermined level of the autonomous movement performance enters the accommodation area, and causes a second moving body to enter the accommodation area after notifying the second moving body of a second path which is a movement path of the second moving body in the accommodation area when the second moving body having the autonomous movement performance higher than the predetermined level enters the accommodation area.

### CROSS-REFERENCE TO RELATED APPLICATIONS

This application is based upon and claims the benefit of priority from prior Japanese patent application No. 2020-061642, filed on Mar. 30, 2020, the entire contents of which are incorporated herein by reference.

### TECHNICAL FIELD

The present invention relates to an accommodation area management device which manages an accommodation area capable of accommodating a moving body.

### BACKGROUND ART

In a recent year, a technique for managing parking of a vehicle capable of autonomous driving has been known. For example, JP-A-2016-6603 discloses a technique in which destination information indicating a position of a destination is transmitted to a vehicle so that the vehicle is moved to the position of the destination by autonomous driving.

However, in the related art, there is room for improvement from a viewpoint of reducing a processing load of a management device which manages an accommodation area while appropriately managing the accommodation area for accommodating a moving body such as a vehicle. For example, there are two types of vehicles: a vehicle which cannot be parked by autonomous driving unless a management device notifies a traveling route and a vehicle which can create its own traveling route and be park by autonomous driving. However, even for the latter vehicle, the management device creates a traveling route, which increases a processing load of the management device.

### SUMMARY OF INVENTION

The invention provides an accommodation area management device capable of reducing a processing load of the accommodation area management device which manages an accommodation area while appropriately managing the accommodation area for accommodating a moving body.

According to an aspect of the present invention, there is provided an accommodation area management device which manages an accommodation area capable of accommodating the moving body. The accommodation area management device includes an acquisition unit configured to acquire information on a moving body which includes information indicating an autonomous movement performance of the moving body, and a control unit which causes a first moving body to enter the accommodation area after notifying the first moving body of a first route which is a movement route of the first moving body in the accommodation area when the first moving body having a predetermined level of the autonomous movement performance enters the accommodation area, and causes a second moving body to enter the accommodation area after notifying the second moving body of a second path which is a movement path of the second moving body in the accommodation area when the second moving body having the autonomous movement performance higher than the predetermined level enters the accommodation area.

According to another aspect of the present invention, there is provided an accommodation area management device which manages an accommodation area capable of accommodating the moving body. The accommodation area management device includes an acquisition unit configured to acquire information on a moving body which includes information indicating an autonomous movement performance of the moving body, and a control unit which causes a first moving body to enter the accommodation area after notifying the first moving body of a movement route of the first moving body to an accommodation position of the first moving body in the accommodation area when the first moving body having a predetermined level of the autonomous movement performance enters the accommodation area and causes a second moving body to enter the accommodation area after notifying the second moving body of an accommodation position of the second moving body in the accommodation area when the second moving body having the autonomous movement performance higher than the predetermined level enters the accommodation area.

According to the invention, it is possible to reduce the processing load of the accommodation area management device which manages the accommodation area while appropriately managing the accommodation area for accommodating the moving body,

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device.

FIG. 3 is a diagram illustrating an example of a configuration of the parking lot management device.

FIG. 4 is a diagram illustrating an example of a parking space information table.

FIG. 5 is a flowchart illustrating an example of a parking area management process performed by the parking lot management device.

### DESCRIPTION OF EMBODIMENT

Hereinafter, an embodiment of a parking lot management device of the invention will be described with reference to the accompanying drawings. In the following description of the embodiment, an example will be described in which a moving body in the invention is a vehicle such as an automobile and an accommodation area in the invention is a parking lot and a parking area in the parking lot.

First, the vehicle of the embodiment will be described. The vehicle (hereinafter, also referred to as vehicle M) of the embodiment is a vehicle having a drive source and wheels (for example, two wheels, three wheels, or four wheels) including driving wheels driven by power of the drive source. The drive source of the vehicle M is, for example, an electric motor. Further, the drive source of the vehicle M may be an internal combustion engine such as a gasoline engine or a combination of an electric motor and an internal combustion engine.

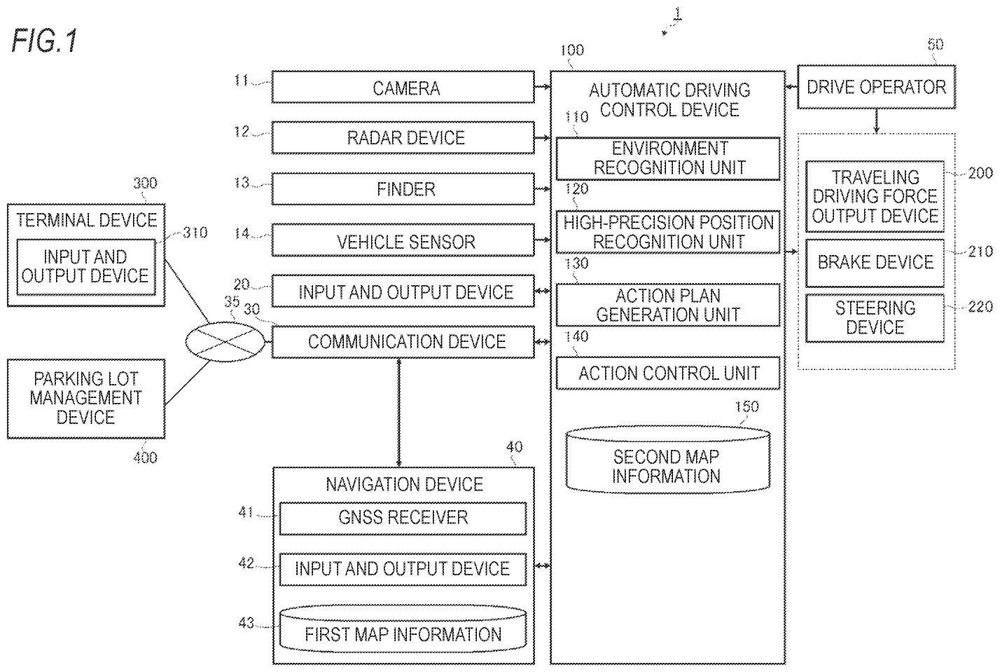

The vehicle M is equipped with a vehicle system 1 illustrated in FIG. 1. The vehicle system 1 has a function capable of performing all driving tasks related to the vehicle M, at least within a limited specific area (for example, in parking lot PA described below). Here, the driving task is, for example, a real-time driving function necessary for maneuvering the vehicle M such as controlling a. left-right movement (steering) of the vehicle M, controlling a forward-backward movement (acceleration, deceleration), and monitoring the driving environment, and a tactical function such as planning a traveling track.

As illustrated in FIG. 1, the vehicle system 1 includes, for example, a camera 11, a radar device 12, a finder 13, a vehicle sensor 14, an input and output device 20, a communication device 30, a navigation device 40, a drive operator 50, an automatic driving control device 100, a traveling driving force output device 200, a brake device 210, a steering device 220. Each of those devices is communicably connected to each other by a wired or wireless communication network. The communication network connecting each of those devices is, for example, Controller Area Network (CAN).

The camera 11 includes a digital camera which photographs the periphery (for example, in front of the vehicle M) of the vehicle M. The camera outputs image data obtained by the photographing to the automatic driving control device 100.

The radar device 12 is, for example, a radar device using radio waves in a millimeter wave band, detects a position of an object in the vicinity (for example, in front of, behind, and to the side of the vehicle M of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication environment) used by the communication device 30 for communication. The vehicle sensor 14 outputs the detection result of each sensor to the automatic driving control device 100.

The input and output device 20 includes an output device which outputs various kinds of information to a user (hereinafter, also simply referred to as a user) of the vehicle M and an input device which accepts various input operations from a user. The output device of the input and output device 20 is, for example, a display which displays based on a processing result of the automatic driving control device 100. The output device may be a speaker, a buzzer, an indicator light, or the like. Further, the input device of the input and output device 20 is, for example, a touch panel or an operation button (key, switch, or the like) which outputs an operation signal corresponding to an input operation received from a user to the automatic driving control device 100.

The communication device 30 is wirelessly connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carried by a user of the vehicle M. The terminal device 300 is, for example, a smartphone or a tablet terminal and is an electronic device connected to the network 35 and including an input and output device 310. The input and output device 310 is, for example, a display which displays various kinds of information to a user, a touch panel which accepts a. user's input operation, and the like.

The navigation device 40 includes a Global Navigation Satellite System (GNSS) receiver 41 and an input and output device 42. Further, the navigation device 40 includes a storage device (not illustrated) such as a hard disk drive (hereinafter, also referred to as HDD) and a flash memory and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user and an input device which accepts various input operations from a user. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

Although detailed description is omitted, the navigation device 40 determines, for example, a route (hereafter also referred to as the route on the map) from the position of the vehicle M specified by the GNSS receiver 41 to a destination input by a user with reference to the first map information 43. Then, the navigation device 40 guides a user on the determined route on the map by the input and output device 42.

Some or all of the functions of the navigation device 40 may be realized by the terminal device 300. Further, some or all of the functions of the navigation device 40 may be realized by an external server (navigation server) capable of communicating with the vehicle system 1 by the communication device 30 or the like.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the internal combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100. the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction (that is, the steering angle) of the steering wheels.

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from a parking lot management device 400. Then, the automatic driving control device 100 updates the second map information 150 so as to incorporate the received in-parking-lot map information into the second map information 150. As a result, the automatic driving control device 100 can specify the position of each parking space PS in the parking lot PA with reference to the second map information 150.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processing Unit (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processing Unit (GPU), and for example, the storage device for storing the second map information 150 and the high-precision position recognition unit 120 may be realized by a Map Positioning Unit (MPU). Further, a part or all of the functional units included in the automatic driving control device 100 may be realized by the cooperation of software and hardware.

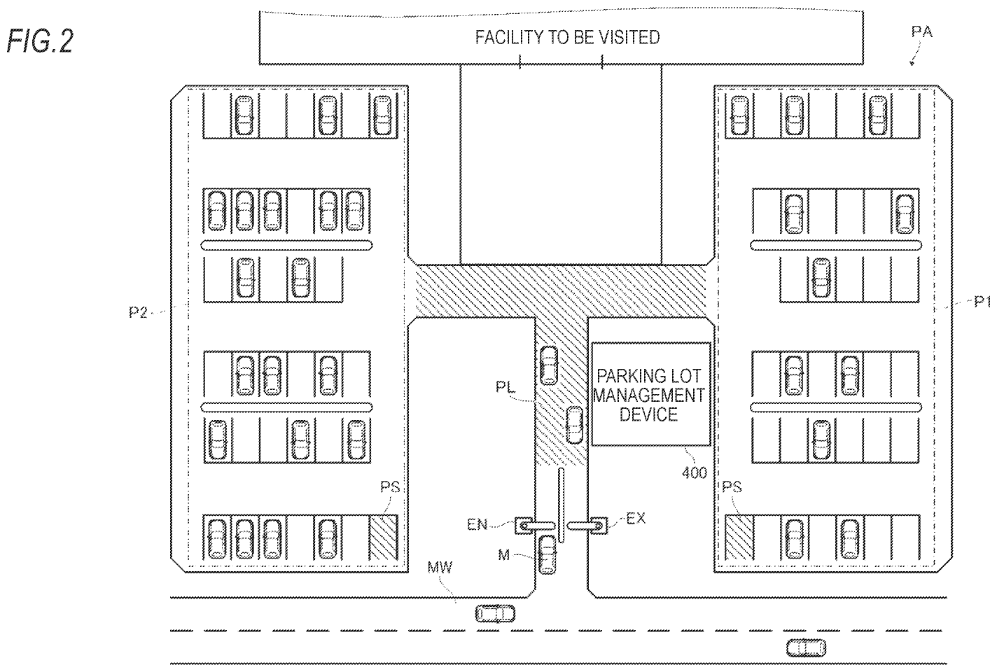

Next, an example of the parking lot PA will be described with reference to FIG. 2. As illustrated in FIG. 2, the parking lot PA is a parking lot managed by the parking lot management device 400 and is an automatic valet parking type parking lot attached to a visited facility to be visited by a user. An entrance gate EN that the vehicle passes through when entering the parking lot PA and an exit gate EX that the vehicle passes through when exiting from the parking lot PA are provided right before a platform PL of the parking lot PA. The parking lot PA includes a first parking area P1 and a second parking area P2 as accommodation areas.

A plurality of parking spaces PS each of which is able to accommodate one vehicle (for example, vehicle M) are provided in each of the first parking area P1 and the second parking area P2. Further, the platform PL is provided right before the first parking area P1 and the second parking area P2. In this example, the first parking area P1 is provided on the right side of the platform PL and the second parking area P2 is provided on the left side of the platform PL. The second parking area P2 is an area where a second vehicle (hereinafter, also referred to as second vehicle M2) and a third moving body (hereinafter, also referred to as third vehicle M3) as a first moving body having a predetermined level of autonomous driving performance are parked. The first parking area P1 is an area where a first vehicle (hereinafter, also referred to as first vehicle M1) as a second moving body having an autonomous driving performance higher than a predetermined level is mainly parked.

The level (hereafter, also referred to as autonomous driving level) of autonomous driving performance indicates a level at which the vehicle M can autonomously be traveled (moved). For example, the more driving tasks (operations) that the vehicle M can autonomously perform, the higher the level is given.

More specifically, for example, a vehicle which implements a route plan to a parking position specified by the parking lot management device 400, moves While recognizing the position of the own vehicle along the planned route without receiving guidance or support from other devices (for example, parking lot management device 400), and can be parked in the parking position specified by the parking lot management device 400 is considered to have a high autonomous driving level. The first vehicle M1 is a vehicle of this level.

Also, a vehicle which moves while recognizing the position of the own vehicle according to the route plan implemented by the parking lot management device 400 and can be parked at a parking position specified by the parking lot management device 400 is considered to have a medium autonomous driving level. The second vehicle M2 is a vehicle of this level.

Then, a vehicle which moves while referring to the position of the own vehicle notified from the parking lot management device 400 according to the route plan implemented by the parking lot management device 400 and can be parked at a parking position specified by the parking lot management device 400 is considered to have a low autonomous driving level. The third vehicle M3 is a vehicle of this level.

A function of executing the route plan to the parking position specified by the parking lot management device 400, that is, a function of searching and determining a route to the parking position specified by the parking lot management device 400 is also referred to as a route plan implementation function. In addition, a function of recognizing the position of the own vehicle in the parking lot PA is also hereinafter referred to as a self-position recognition function. The first vehicle M1 is a vehicle having the route plan implementation function and the self-position recognition function. The second vehicle M2 is a vehicle which does not have the route plan implementation function but has the self-position recognition function. The third vehicle M3 is a vehicle which does not have both the route plan implementation function and the self-position recognition function.

Here, an operation example of the vehicle M, a user, and the parking lot management device 400 when the user of the vehicle M uses the parking lot PA will be described. Prior to using the parking lot PA. a user makes a usage reservation (hereinafter, also referred to as a parking reservation) for the parking lot PA using the terminal device 300 or the like, This “user” is not limited to the owner and manager of the vehicle M, but includes, for example, a person (for example, a concierge) who performs procedures such as parking reservation on behalf of the owner of the vehicle M. In this parking reservation, the user inputs a vehicle ID, which is an identifier (identification information) of the vehicle the scheduled parking time for parking the vehicle M in the parking lot PA, and the like. As the scheduled parking time, for example, the scheduled entry date and time when the vehicle M is scheduled to enter the parking lot PA and the scheduled exit date and time when the vehicle M is scheduled to exit from the parking lot PA are input. The information entered by the user is sent to the parking lot management device 400. With reference to the received information and the management table (not illustrated) showing the parking reservation status of the parking lot PA, the parking lot management device 400 determines whether there is a parking space PS where the vehicle M can be parked during the scheduled parking time (the period from the scheduled entry date and time to the scheduled exit date and time). Then, when there is a parking space PS in which the vehicle M can be parked, the parking lot management device 400 accepts the parking reservation and notifies the user of that effect.

After that, when the reserved date and time arrives, a user drives the vehicle M to the front of the entrance gate EN and temporarily stops it. Here, the vehicle M transmits the autonomous driving level information of the own vehicle to the parking lot management device 400 in association with the vehicle ID of the own vehicle. For example, the vehicle M (first vehicle M1) provided with the route plan implementation function transmits information indicating “high” as autonomous driving level information indicating the autonomous driving level of the own vehicle. Further, the vehicle M (second vehicle M2) which does not have the route plan implementation function but has the self-position recognition function transmits information indicating “medium” as the autonomous driving level information indicating the autonomous driving level of the own vehicle. Then, the vehicle M (third vehicle M3) which does not have both the route plan implementation function and the self-position recognition function transmits information indicating “low” as the autonomous driving level information indicating the autonomous driving level of the own vehicle.

Further, the vehicle M may transmit information indicating the function of the own vehicle among the functions related to the autonomous driving as the autonomous driving level information. For example, the vehicle M (first vehicle M1) having the route plan implementation function and the self-position recognition function may transmit information indicating the route plan implementation function “Yes” and the self-position recognition function “Yes” as the autonomous driving level information indicating the autonomous driving level of the own vehicle. In addition, the vehicle M (second vehicle M2) which does not have the route plan implementation function but has the self-position recognition function may transmit information indicating the route plan implementation function “No” and the self-position recognition function “Yes” as autonomous driving level information indicating the autonomous driving level of the own vehicle. Then, the vehicle M (third vehicle M3) which does not have the route plan implementation function and the self-position recognition function may transmit information indicating the route plan implementation function “No” and the self-position recognition function “No as the autonomous driving level information indicating the autonomous driving level of the own vehicle.

The parking lot management device 400 acquires information (autonomous driving level information) including the autonomous driving performance (autonomous movement performance) of the vehicle M arriving at a predetermined entrance position (in this embodiment, it is before the entrance gate EN) via, for example, a communication unit 410. Then, the parking lot management device 400 performs processing according to the autonomous driving performance of the vehicle M. Specifically, when the autonomous driving performance of the vehicle M is higher than a predetermined level, a process of designating the parking space PS in the first parking area P1 is mainly performed for the vehicle M. When the autonomous driving performance of the vehicle M is at the predetermined level, a process of designating the parking space PS in the second parking area P2 and a traveling route to the parking space PS is performed for the vehicle M. Then, the parking lot management device 400 opens the entrance gate EN.

After the entrance gate EN is opened, the vehicle M is automatically driven and moves to the platform PL through the entrance gate EN. A user of the vehicle M gets off from the vehicle M on the platform PL.

After the user gets off the vehicle M, the vehicle M is automatically driven and starts a self-propelled entry event to move to the parking space PS in the parking lot PA. For example, the user uses the terminal device 300 to send a start request for a self-propelled entry event to the parking lot management device 400. In response to this start request, the parking lot management device 400 instructs the vehicle M to perform a self-propelled entry event for parking in a predetermined parking space PS. According to this instruction, the vehicle M moves to the parking space PS instructed by the parking lot management device 400 while performing guidance by the parking lot management device 400 and sensing with the camera 11, the radar device 12, the finder 13, or the like.

In addition, at the time of exiting from the parking lot PA, the vehicle M performs a self-propelled exit event to move from the parking space PS to the platform PL by performing automatic driving. For example, the user uses the terminal device 300 to send a start request for the self-propelled exit event to the parking lot management device 400, In response to this start request, the parking lot management device 400 instructs the vehicle Ni to perform the self-propelled exit event to move from the parking space PS where the vehicle M is parked to the platform PL. According to this instruction, the vehicle M moves to the platform PL while performing guidance by the parking lot management device 400 and sensing with the camera 11, the radar device 12, the finder 13, or the like. The user gets on the vehicle M on the platform PL and exits from the parking lot PA through the exit gate EX.

Next, the parking lot management device 400 will he described. The parking lot management device 400 is a device (computer) which manages the parking lot PA. For example, the parking lot management device 400 determines the parking position of the vehicle entering the parking lot PA or instructs the vehicle to move to the determined parking position.

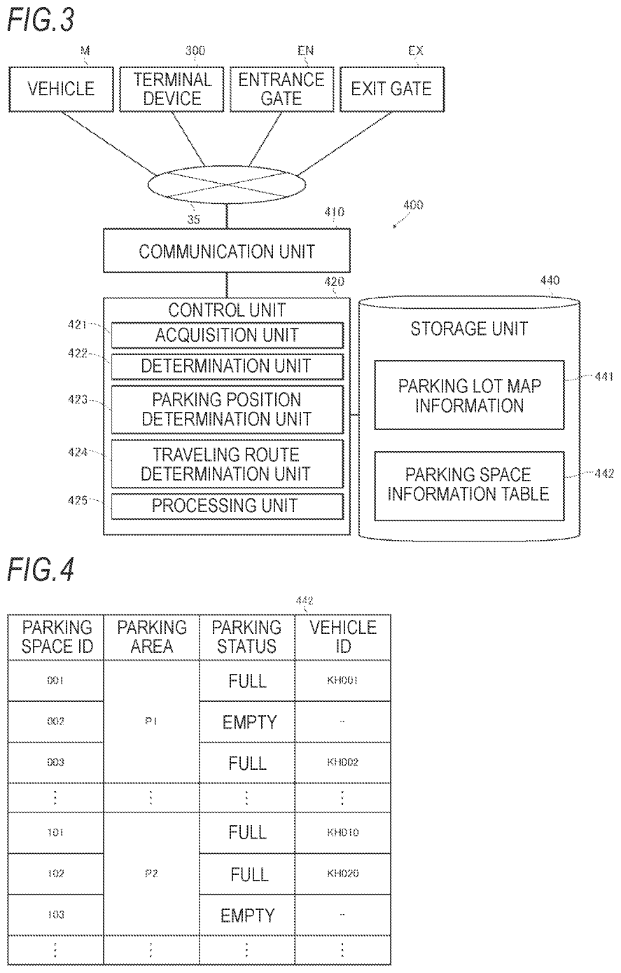

More specifically, the parking lot management device 400 includes a communication unit 410. a control unit 420, and a storage unit 440, as illustrated in FIG. 3. The communication unit 410 and the control unit 420 are realized, for example, by the CPU executing a predetermined program (software) stored in advance. Further, some or all of these functional units may be realized by hardware such as LSI, ASIC, FPGA, GPU or may be realized by collaboration between software and hardware. The storage unit 440 is realized by an HDD, a flash memory, or the like.

Information such as parking lot map information 441 and a parking space information table 442 is stored in the storage unit 440. The parking lot map information 441 is information which geometrically represents the structure of the parking lot PA, and includes, for example, information indicating the coordinates (positions) of each parking space PS.

As illustrated in FIG. 4, the parking space information table 442 stores, for example, information in which a parking space ID, a parking area, a parking status, and the vehicle ID are associated with each other. Here, the parking space ID is an identifier (identification information) which identifies each parking space PS. The parking area indicates whether it is the parking space PS of the first parking area PI or the parking space PS of the second parking area P2.

In addition, the parking status indicates whether any vehicle is parked in the corresponding parking space PS. For example, when a vehicle is parked, the parking status is set to “full”, and when a vehicle is not parked, it is set to “empty”. The vehicle ID is an identifier of each vehicle as described above. In the parking space information table 442, the vehicle ID is stored in association with the parking space PS in which the parking status is “full” and indicates the vehicle parked in the parking space PS.

The communication unit 410 communicates with the vehicle M, the terminal device 300, the entrance gate EN, and the exit gate EX wirelessly or by wire (for example, network 35). The control unit 420 includes an acquisition unit 421, a determination unit 422, a. parking position determination unit 423, a traveling route determination unit 424, and a processing unit 425. The control unit 420 performs various processes based on the information acquired via the communication unit 410 and the information stored in the storage unit 440.

The acquisition unit 421 acquires the autonomous driving level information of the vehicle M. The acquisition of the autonomous driving level information by the acquisition unit 421 is performed, for example, by communicating with the vehicle M arriving before the entrance gate EN via the communication unit 410. Further, the acquisition of the autonomous driving level information may be performed, for example, by communicating with the terminal device 300 or the like used for the parking reservation at the time of parking reservation. Further, in this way, when the autonomous driving level information is acquired before the vehicle M arrives before the entrance gate EN, the acquisition of the autonomous driving level information of the vehicle M before the entrance gate EN may be omitted.

In addition, based on the autonomous driving level information acquired at the time of parking reservation and the autonomous driving level information acquired when the vehicle is arrived before the entrance gate EN, whether the vehicle for which the parking reservation is made and the vehicle which is arrived before the entrance gate EN are the same vehicle may be checked. Further, the autonomous driving level information may be acquired at an arbitrary point where the approach to the parking lot PA can be confirmed, not before the entrance gate EN. In this case, for example, not limited to communication with the vehicle M, for example, based on a recognition result of a captured image of the camera which captures the vehicle M, or the like, the autonomous driving level information of the vehicle M may be acquired.

The determination unit 422 determines the autonomous driving level of the vehicle M based on the autonomous driving level information acquired by the acquisition unit 421. Specifically, the determination unit 422 determines whether the autonomous driving level is “high”, “medium”, or “low”.

The parking position determination unit 423 determines the position where the vehicle M is parked, that is, the parking space PS, based on the determination result by the determination unit 422. Specifically, when the autonomous driving level of the vehicle M is determined to be “high”, the empty parking space PS in the first parking area P1 is mainly determined as the position for parking the vehicle M. When the autonomous driving level of the vehicle M is determined to be “medium” or “low”, the empty parking space PS in the second parking area P2 is determined as the position for parking the vehicle M.

When the parking space PS in the second parking area P2 is determined as the parking space PS for parking the vehicle M, the traveling route determination unit 424 determines an appropriate traveling route (movement route) to the parking space PS (accommodation position), The traveling route is determined in consideration of the distance to the parking space PS, the situation of vehicle congestion in the parking lot PA, and the like.

The processing unit 425 performs various processes according to the processing results of the determination unit 422, the parking position determination unit 423, and the traveling route determination unit 424. Various processes performed by the processing unit 425 includes a process to notify the first vehicle M1 of the parking lot map information 441, a process to notify the first vehicle M1 of the parking space PS determined by the parking position determination unit 423, a process to receive the traveling route notified from the first vehicle M1 (second moving body), a process to notify the second vehicle M2 and the third vehicle M3 of the traveling route determined by the traveling route determination unit 424, a process of notifying the third vehicle M3 of the current position of the vehicle M, and the like.

More specifically, when the first vehicle M1 (second moving body), that is, the vehicle M determined to have a “high” autonomous driving level, is admitted to enter the parking lot PA, the processing unit 425 notifies the first vehicle M1 of the parking space PS determined by the parking position determination unit 423, opens the entrance gate EN after the first vehicle M1 notifies the traveling route (second route) of the vehicle M in the parking lot PA, and allows the vehicle M to enter the parking lot PA.

In addition, when the second vehicle M2 (first moving body), that is, the vehicle M determined to have a “medium” autonomous driving level is admitted to enter the parking lot PA, the processing unit 425 notifies the vehicle M of the traveling route (first route) determined by the traveling route determination unit 424, and then opens the entrance gate EN to allow the vehicle M to enter the parking lot PA.

In addition, when the third vehicle M3 (first moving body), that is, the vehicle M determined to have a “low” autonomous driving level is admitted to enter the parking lot PA, the processing unit 425 opens the entrance gate EN and allows the vehicle M to enter the parking lot PA after notifying the vehicle M of the traveling route (first route) determined by the traveling route determination unit 424. Then, the processing unit 425 notifies the third vehicle M3 of the current position while the third vehicle M3 exists in the parking lot PA. The processing unit 425 may notify the third vehicle M3 of only the traveling route without notifying the current position.

As described above, in the embodiment, when the vehicle M (first moving body) determined to have the autonomous driving level of “medium” or “low” is admitted to enter the parking lot PA, the vehicle M is allowed to enter the parking lot PA after notifying the vehicle M of the traveling route (first route) of the vehicle M in the parking lot PA. However, when the vehicle M (second moving vehicle) determined to have a “high” autonomous driving level is admitted to enter the parking lot PA, the vehicle M is allowed to enter the parking lot PA after the traveling route (second route) of the vehicle M in the parking lot PA is notified from the first vehicle M1. As a result, it is possible to reduce the processing load of the parking lot management device 400 which manages the parking lot PA while appropriately managing the parking lot PA. In addition, regardless of the autonomous driving level (“high”, “medium”, “low”) of the vehicle M, the parking lot management device 400 determines the parking space PS for parking the vehicle M, so the parking lot PA can be appropriately managed.

Further, in the embodiment, the parking lot PA has the first parking area P1 and the second parking area P2 arranged by interposing the platform PL therebetween. The parking position determination unit 423 mainly determines the parking space PS (accommodation position) of the vehicle M (second moving body) determined to have a “high” autonomous driving level to be the parking space PS in the first parking area P1. Further, the parking position determination unit 423 determines the parking space PS (accommodation position) of the vehicle M (second moving body) determined to have the autonomous driving level of “medium” or “low” is determined to be the parking space PS in the second parking area P2. As a result, the vehicles M can he distributed and accommodated in the parking spaces PS according to the autonomous driving level, so that the parking lot PA can be appropriately managed.

Further, in the embodiment, When it is necessary to modify the traveling route (second route) notified from the vehicle M (second moving body) determined to have the “high” autonomous driving level, the processing unit 425 gives an instruction to modify the traveling route to the vehicle M. For example, When there is a traffic jam or an obstacle on the traveling route created by the vehicle M, the parking lot management device 400 notifies the vehicle M to that effect. Upon receiving the modification instruction, the vehicle M recreates the traveling route (second route) by reflecting the instruction content. This enables the smooth movement of the vehicle M in the parking lot PA.

Further, in the embodiment, when it is necessary to modify the traveling route (second route) notified from the vehicle M (second moving body) determined to have the “high” autonomous driving level, the processing unit 425 gives an instruction to the vehicle M to modify the traveling route including the modification contents according to the current position of the vehicle M. The modification content is a partial modification included in the traveling route notified by the vehicle M. As a result, the vehicle M can appropriately modify the traveling route until reaching the parking space PS according to the current position of the own vehicle M. Further, since the modification content is a modification of a part of the traveling route generated by the vehicle M, the modification of the traveling route can be simplified. In addition, the modification described above may involve a change in the parking space PS (accommodation position). When the change in the parking space PS is involved, a modification instruction may be given that includes the traveling route to another parking space (accommodation position) after the change as the modification content.

Moreover, in this embodiment, the control unit 420 may perform a process of entering the vehicle M (second moving body) determined to have the “high” autonomous driving level into the parking lot PA as the vehicle M (first moving body) determined to have the autonomous driving level of “medium” or “low”. Specifically, the parking position determination unit 423 has a function of determining the parking space PS (movement position) of the first vehicle M1 to the parking space PS in the second parking area P2 for parking the second vehicle M2 and the third vehicle M3. Then, the processing unit 425 notifies the first vehicle M1 of the traveling route (third route) leading to the parking space PS. As a result, the first vehicle M1 (second moving body) can be parked in the parking space PS in the second parking area P2, so that the parking spaces PS in the parking lot PA can be effectively utilized. For example, when the first parking area P1 is full, the first vehicle M1 can be parked in the parking space PS in the second parking area P2.

Further, in the embodiment, when it is necessary for the control unit 420 to move any of the vehicles M parked in the parking spaces PS in the second parking area P2 (accommodation area, if there is a first vehicle M1 (second moving body) which has entered the second parking area P2 as the second vehicle M2 or the third vehicle M3 (first moving body), the first vehicle M1 (second moving body) is moved with priority over the second vehicle M2 or the third vehicle M3 (first moving body). For example, when the first vehicle M1 is parked in the parking space PS in the second parking area P2, the control unit 420 performs a process (reparking) of moving the first vehicle MI to the parking space PS in the first parking area P1 as soon as the parking space PS in the first parking area P1 becomes available. As a result, as a result of parking the first vehicle M1 in the parking space PS in the second parking area P2, the inconvenience that the second vehicle M2 and the third vehicle M3 cannot use the second parking area P2 is suppressed. Thus, the first parking area P1 and the second parking area P2 can be effectively used.

Further, as a modification example of the embodiment, when the vehicle M (first moving body) determined to have the autonomous driving level of “medium” or “low” is admitted to enter the parking lot PA, the processing unit 425 notifies the vehicle M of the traveling route (first route) to the parking position of the vehicle M in the parking lot PA, and then causes the vehicle M to enter the parking lot PA. On the other hand, when the vehicle M (second moving body) determined to have the “high” autonomous driving level is admitted to enter the parking lot PA, the processing unit 425 notifies the vehicle M only of the parking position, and then causes the vehicle M to enter the parking lot PA. Even in this way, the processing load of the control unit 420 can be reduced while appropriately managing the first parking area P1 and the second parking area P2 (accommodation area).

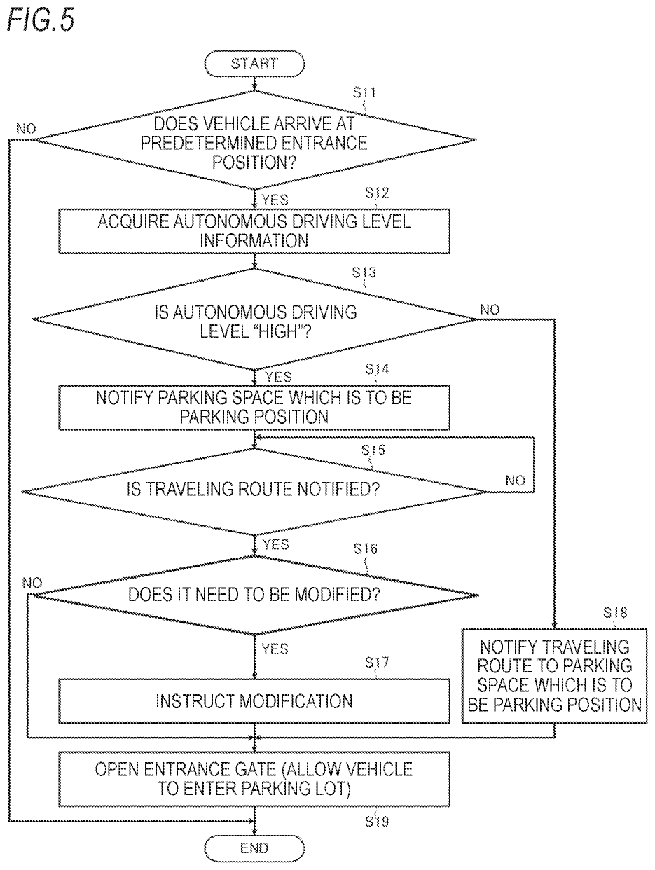

Next, an example of a parking area management process performed by the parking lot management device 400 will be described with reference to FIG. 5.

As illustrated in FIG. 5, the parking lot management device 400 determines whether the vehicle M arrives at a predetermined entrance position (Step S11). In this embodiment, an example in which the entrance position is before the entrance gate EN will be described. When the vehicle M arrives before the entrance gate EN, the entrance gate EN is closed. The entrance position is not limited to before the entrance gate EN. For example, it is conceivable that the entrance position is set to the platform P1. without providing a physical gate (for example, a bar) such as the entrance gate EN right before the platform PL, in this case, the parking lot management device 400 may determine that the vehicle M has arrived at the entrance position when the vehicle M arrives at the platform PL, for example, by manual driving by a user. When it is determined that the vehicle M has not arrived at the entrance position, that is, when it is determined that the vehicle M has not arrived before the entrance gate EN (NO in Step S11), the parking lot management device 400 ends the parking area management process illustrated in FIG. 5.

When it is determined that the vehicle M has arrived at the entrance position, that is, when it is determined that the vehicle M has arrived before the entrance gate EN (YES in Step S11), the parking lot management device 400 acquires information (autonomous driving level information) indicating an autonomous movement performance of the vehicle M (Step S12). Next, the parking lot management device 400 determines whether the autonomous driving level of the vehicle M is “high” based on the information indicating the autonomous movement performance acquired by the process of Step S12 (Step S13).

When it is determined that the autonomous driving level of the vehicle M is “high” (YES in Step S13), the parking lot management device 400 notifies the vehicle M of the parking space PS to be the parking position (Step S14). The vehicle M generates a traveling route (second route) based on the parking space PS and the parking lot map information 441 notified from the parking lot management device 400.

Next, the parking lot management device 400 determines whether the vehicle M has notified the traveling route (second route) (Step S15). When it is determined that the traveling route is not notified (NO in Step S15), the parking lot management device 400 waits until the traveling route is notified.

When it is determined that the vehicle M has notified the traveling route (YES in Step S15), the parking lot management device 400 determines whether the traveling route (second route) notified by the vehicle M needs to be modified (Step S16). When it is determined that the modification is not necessary (NO in Step S16), the parking lot management device 400 opens the entrance gate EN (Step S19). When it is determined that the modification is necessary (YES in Step S16), the parking lot management device 400 notifies the vehicle M of a modification instruction (Step S17) and then opens the entrance gate EN (Step S19). Then, in this case, the vehicle M enters the parking lot PA from the opened entrance gate EN, disembarks an occupant on the platform PL, and then moves to the parking space PS along the traveling route created by the own vehicle M. In addition, when the parking lot management device 400 notifies the vehicle M of the modification instruction, the entrance gate EN may be opened on condition that the vehicle M has notified that the modification based on the modification instruction has been completed. When a physical gate such as entrance gate EN is not provided right before the platform PL and the entrance position is the platform PL, the parking lot management device 400 may end the parking area management process illustrated in FIG. 5 without performing the process of Step S19.

On the other hand, when the autonomous driving level of vehicle M is not determined to be “high”, that is, when the autonomous driving level of the vehicle M is determined to be “medium” or “low” (NO in Step S13), the parking lot management device 400 notifies the vehicle M of the traveling route to the parking space PS, which is the parking position (Step S18), and then opens the entrance gate EN (Step S19), Then, in this case, the vehicle M enters the parking lot PA from the opened entrance gate EN, disembarks an occupant on the platform PL, and then moves to the parking space PS along the traveling route notified from the parking lot management device 400.

The invention is not limited to the embodiment described above and can be appropriately modified, improved, and the like. For example, in the embodiment described above, an example in which the moving body is a vehicle is described, but the invention is not limited to this. The idea of the invention can be applied not only to a vehicle but also to a robot, a ship, an aircraft, and the like which have a drive source and can move by the power of the drive source. Similarly, the accommodation area may be a hangar, a berth, a parking apron, or the like. In addition, automatic driving is a concept which includes autonomous movement.

Further, under the concept of the invention, “parking” is extended to the concept of “stop”, and “traveling” is extended to the concept of “movement”, and further “parking lot management device” of the embodiment is extended to the concept of “accommodation area management device”. The repacking also includes an operation of “restopping to change the accommodation position of the stopped moving body to another accommodation position in the accommodation area” or “the stopped moving body moves to another accommodation position in the containment area and stops again”.

Further, in the embodiment described above, when it is necessary to modify the traveling route created by the first vehicle M1, the parking lot management device 400 notifies the first vehicle M1 of the modification instruction, and then the first vehicle M1 which received the modification instruction recreates the traveling route. However, instead of this, the parking lot management device 400 may modify the traveling route and notify the first vehicle M1 of the modified traveling route. As a result, the processing load on the first vehicle M1 side can be reduced.

Further, in the embodiment described above, the case where the parking lot PA has one entrance gate EN is described, but the parking lot PA may have a plurality of entrance gates EN. When there are a plurality of entrance gates EN, the parking lot management device 400 creates a traveling route from an appropriate entrance gate EN considering the current position of the vehicle M and its parking space PS and notifies the vehicle M of the traveling route, in such a manner that it is possible to facilitate the movement of the vehicle M in the parking lot PA.

Further, in the embodiment described above, the first parking area P1 and the second parking area P2 are provided on the left and right sides of the platform PL, but the first parking area P1 may be provided after passing through the second parking area P2. In this case, the first vehicle M1 can reach the parking space PS in the first parking area P1 passing through the second parking area P2.

Further, in the embodiment described above, although the case of allocating the parking areas for three types of vehicles having different autonomous driving levels is described, the parking areas may be allocated for two types of vehicles having different autonomous driving levels. For example, the first vehicle MI and the second vehicle M2 may be targeted and the first vehicle M1 may be parked mainly in the parking space PS in the first parking area PI, and further the second vehicle M2 may be parked in the parking space PS in the second parking area P2. In addition, the first vehicle M1 and the third vehicle MS may be targeted and the first vehicle M1 may be parked mainly in the parking space PS in the first parking area P1, and further the third vehicle M3 may be parked in the parking space PS in the second parking area P2. Further, the first vehicle MI and the second vehicle M2 may be parked in the parking spaces PS in the first parking area P1 and the third vehicle M3 may be parked in the parking space PS in the second parking area P2. In this case, only the third vehicle M3, which requires the parking lot management device 400 to generate the traveling route and recognize the position of the vehicle, is parked in the second parking area P2, and thus it is possible to simplify the monitoring and management of the first parking area P1 by equipment of the first parking area P1 and the parking lot management device 400.

Further, although not mentioned in the embodiment described above, the third vehicle M3 does not need to have advanced position and object detection functions such as the radar device 12 and the finder 13.

In addition, at least the following matters are described in this specification. The components and the like corresponding to those of the embodiment described above are shown in parentheses, but the invention is not limited thereto.

(1) An accommodation area management device (parking lot management device 400) which manages an accommodation area (first parking area P1, second parking area P2) capable of accommodating the moving body, including

an acquisition unit (acquisition unit 421) configured to acquire information on a moving body (vehicle M) which includes information indicating an autonomous movement performance of the moving body, and

a control unit (control unit 420) which causes a first moving body (second vehicle M2, third vehicle M3) to enter the accommodation area after notifying the first moving body of a first route which is a movement route of the first moving body in the accommodation area when the first moving body having a predetermined level of the autonomous movement performance enters the accommodation area, and

causes a second moving body (first vehicle M1) to enter the accommodation area after notifying the second moving body of a second path which is a movement path of the second moving body in the accommodation area when the second moving body having the autonomous movement performance higher than the predetermined level enters the accommodation area.

According to (1), it is possible to reduce the processing load of the accommodation area management device which manages the accommodation area while appropriately managing the accommodation area for accommodating the moving body.

(2) The accommodation area management device according to (1), where

the first route and the second route are routes to the accommodation position determined by the accommodation area. management device.

According to (2), since the accommodation area management device determines the accommodation position of the moving body, the accommodation area can be appropriately managed.

(3) The accommodation area management device according to (2), where

the accommodation position is determined based on the autonomous movement performance.

According to (3), since the moving body can be accommodated in the accommodation position based on its autonomous movement performance, the accommodation area can be appropriately managed.

(4) The accommodation area management device according to any one of (1) to (3), where

the control unit gives a modification instruction for the second path to the second moving body when the second path needs to be modified.

According to (4), when the second path needs to be modified, the modification instruction for the second path is given to the second moving body, so that the second moving body can be moved smoothly in the accommodation area.

(5) The accommodation area management device according to (4), where

the modification instruction includes a modification content of the second path according to a position of the second moving body.

According to (5), since the modification instruction for the second route includes the modification content of the second route according to the position of the second moving body, it is possible to appropriately modify the second route.

(6) The accommodation area management device according to (5), where the modification content is a modification of a part of the second path.

According to (6), since the modification content of the second path is a modification of a part of the second path, the modification of the second path can be simplified.

(7) The accommodation area management device according to any one of (1) to (6), where

it is possible to allow the second moving body to enter the accommodation area as the first moving body, and

the control unit notifies the second moving body of a third path which is a movement path of the second moving body in the accommodation area, and then causes the second moving body to enter the accommodation area when the second moving body is made to enter the accommodation area as the first moving body.

According to (7), when the second moving body is allowed to enter the accommodation area as the first moving body, the second moving body can be made to enter the accommodation area in the same manner as that of the first moving body. As a result, it is possible to effectively utilize the accommodation area while appropriately managing the accommodation area for accommodating the moving body.

(8) The accommodation area management device according to (7), where

the second moving body is moved with priority over the first moving body, if there is the second moving body which is made to enter the accommodation area as the first moving body-when the moving body needs to be moved in the accommodation area.

According to (8), when the moving body needs to be moved in the accommodation area, by preferentially moving the second moving body having the high autonomous movement performance, the movement can be realized while reducing the processing load of the accommodation area management device which manages the accommodation area.

(9) The accommodation area management device according to (8), where it is determined whether the moving body needs to be moved in the accommodation area based on a situation of the accommodation position where the first moving body can be accommodated.

According to (9), the accommodation area can be effectively utilized.

(10) An accommodation area management device (parking lot management device 400) which manages an accommodation area (first parking area P1, second parking area P2) capable of accommodating the moving body, including

an acquisition unit (acquisition unit 421) configured to acquire information on a moving body (vehicle M) which includes information indicating an autonomous movement performance of the moving body, and

a control unit (control unit 420) which causes a first moving body (second vehicle M2 third vehicle M3) to enter the accommodation area after notifying the first moving body of a movement route of the first moving body to an accommodation position of the first moving body in the accommodation area when the first moving body having a predetermined level of the autonomous movement performance enters the accommodation area, and

causes a second moving body (first vehicle M1) to enter the accommodation area after notifying the second moving body of an accommodation position of the second moving body in the accommodation area when the second moving body having the autonomous movement performance higher than the predetermined level enters the accommodation area.

According to (10), it is possible to reduce the processing load of the accommodation area management device which manages the accommodation area while appropriately managing the accommodation area for accommodating the moving body.

What is claimed is:

1. An accommodation area management device which manages an accommodation area capable of accommodating the moving body, comprising:
an acquisition unit configured to acquire information on a moving body which includes information indicating an autonomous movement performance of the moving body; and
a control unit which causes a first moving body to enter the accommodation area after notifying the first moving body of a first route which is a movement route of the first moving body in the accommodation area when the first moving body having a predetermined level of the autonomous movement performance enters the accommodation area, and
causes a second moving body to enter the accommodation area after notifying the second moving body of a second path which is a movement path of the second moving body in the accommodation area when the second moving body having the autonomous movement performance higher than the predetermined level enters the accommodation area.

2. The accommodation area management device according to claim 1, wherein the first route and the second route are routes to the accommodation position determined by the accommodation area management device.

3. The accommodation area management device according to claim 2, wherein
the accommodation position is determined based on the autonomous movement performance.

4. The accommodation area management device according to claims 1, wherein
the control unit gives a modification instruction for the second path to the second moving body when the second path needs to be modified.

5. The accommodation area management device according to claim 4, wherein
the modification instruction includes a modification content of the second path according to a position of the second moving body.

6. The accommodation area management device according to claim 5, wherein
the modification content is a modification of a part of the second path.

7. The accommodation area management device according to claims 1, wherein
it is possible to allow the second moving body to enter the accommodation area as the first moving body, and
the control unit notifies the second moving body of a third path which is a movement path of the second moving body in the accommodation area, and then causes the second moving body to enter the accommodation area when the second moving body is made to enter the accommodation area as the first moving body.

8. The accommodation area management device according to claim 7, wherein
the second moving body is moved with priority over the first moving body, if there is the second moving body which is made to enter the accommodation area as the first moving body when the moving body needs to be moved in the accommodation area.

9. The accommodation area management device according to claim 8, wherein
it is determined whether the moving body needs to be moved in the accommodation area based on a situation of the accommodation position where the first moving body can be accommodated.

10. An accommodation area management device which manages an accommodation area capable of accommodating the moving body, comprising:
an acquisition unit configured to acquire information on a moving body which includes information indicating an autonomous movement performance of the moving body; and
a control unit which causes a first moving body to enter the accommodation area after notifying the first moving body of a movement route of the first moving body to an accommodation position of the first moving body in the accommodation area when the first moving body having a predetermined level of the autonomous movement performance enters the accommodation area, and
causes a second moving body to enter the accommodation area after notifying the second moving body of an accommodation position of the second moving body in the accommodation area when the second moving body having the autonomous movement performance higher than the predetermined level enters the accommodation area.
